(19) United States
(12) Patent Application Publication
(10) Pub. No.: US 2017/0238591 A1
(43) Pub. Date: Aug. 24, 2017

(54) PROCESS FOR THE PREPARATION OF A POWDERED FLAVORING BASED ON MACRURAN DECAPOD CRUSTACEANS, THE FLAVORING PRODUCT OBTAINED WITH IT AND COOKING SALT FLAVORED WITH SAID PRODUCT

(71) Applicant: Borja Blázquez Ancin, Buenos Aires (AR)

(72) Inventor: Borja Blázquez Ancin, Buenos Aires (AR)

(21) Appl. No.: 15/518,826

(22) PCT Filed: Oct. 14, 2015
(86) PCT No.: PCT/IB2015/002089

§ 371 Date: Apr. 13, 2017

Related U.S. Application Data
(60) Provisional application No. 62/063,707, filed on Oct. 14, 2014.

(51) Int. Cl. A23L 17/40; A23L 27/20

(52) U.S. Cl. CPC A23L 17/40; A23L 27/20; A23V 2002/00

(57) ABSTRACT

A process for the preparation of a flavoring powder based on macruran decapod crustaceans that comprises a) having macruran decapod crustacean cephalothoraxes kept at no more than about 2 degrees centigrade, b) optionally adding vegetable oil to the cephalothoraxes, c) heat treating the cephalothoraxes using dry heat at a temperature of between about 160 and about 180 degrees centigrades so that the inside reaches approximately 70 degrees centigrade for a period of approximately 2 minutes, d) extracting the hepatopancreas of the cephalothoraxes in liquid form, e) filtering the creamy liquid obtained without pressure, separating the solids present; f) lyophilizing the filtrated product obtained in e); and g) grinding the product obtained by lyophilization to a powder with a particle size from about 5 μm to about 80 μm. The flavoring product obtained by the process described above, where the macruran decapod crustacean cephalothoraxes come from Patagonian shrimps (Pleoticusmuelleri), being a powder of between about 5 μm to about 80 μm in particle size, and comprising about 39% protein, which does not include chitin, about 43.0% lipids and about 8.0% ash. Cooking flavored salt which comprises from about 10% w/w to about 15% w/w of the powdered flavoring product obtained by the process described above, mixed with sea salt or salt flakes for culinary use, where the % w/w refer to the final mix.

### FIELD OF THE INVENTION

The present invention pertains to the food industry field, in particular the manufacture of flavorings or flavored food.

### DESCRIPTION OF THE PRIOR ART

Shrimps, prawns, langoustines, scampi, crayfish and lobsters are all macruran decapod crustaceans, generally found on the seabed and coasts of all the world's oceans and all these varieties are highly appreciated in gastronomy.

They have an elongated body, an abdomen with a semi-hard carapace, an elongated tail and a keel-shaped beak or rostrum. There are morphological differences among them, particularly in their maximum length and the color of the body.

King shrimp, for example, was already known to the Romans during the 1^{st} century A.D., as an ingredient for making a type of garum called alec. This sauce also included clams, sea urchins, shrimps or mullet livers. Shrimp were used as an appetizer or entree and in sauces accompanying dishes whose main ingredient was fish. In seventeenth century European cooking books, shrimp are mentioned alongside other species of fish and shellfish.

At night, these crustaceans come out in search of food. Their diet is based on mollusks, worms, algae and other crustaceans.

These crustaceans all have similar nutritional characteristics and are noted for their vitamins and minerals. They are a source of the vitamins from groups B and D involved in processes such as the synthesis of genetic material, the production of sex hormones or the formation of red blood cells. The most important minerals they provide include iron, phosphorus and iodine.

Shrimps, prawns and king shrimp are the most widely consumed shellfish because of their distinctive taste, conveniently small size, high reproduction rate both in the wild and in shellfish farms, and the fact that they freeze well.

The largest proportion of the sale of shrimps, prawns and king shrimp is in the frozen form of the product; the catch is frozen on the ship itself, and then distributed to consumer markets all over the world.

The meat of prawns, shrimps and king shrimp tolerates the freezing process better than most fish and, as long as the cold chain has been maintained, is very tasty.

There are different species in different parts of the world, which have different morphological characteristics:

The giant or jumbo tiger shrimp (Penaeusmonodom) from Asia and southern Africa, which is large and typically has transverse stripes on the body.

The brown tiger shrimp (Penaeusesculentus), which comes from the Indian ocean and has a striped body in brown tones.

The green tiger shrimp (Penaeussemisulcatus) from the coast of East Africa, northern Australia, Japan and India, which has a striped body with a greenish tone.

The Pacific white shrimp or white leg shrimp (Litopenaeus vannamei formerly Penaeus vannamei) usually comes from farms on the eastern Pacific coast, and has a uniformly pink body without transverse bands and whitish legs.

Western king shrimp (Melicertuslatisulcatus) from the coast of western Africa has an ivory-colored body.

In addition to the above species, other species are also marketed as shrimp, and although they are not shrimp nor of this genus they have a very similar appearance.

The Argentine prawn (Pleoticusmuelleri or Hymenopenaeus muelleri) from the coast of the South West Atlantic is very similar to the shrimp but reddish in color.

The Mozambican prawn (Metapenaeus monoceros), whose body is covered with small spots or marks, comes mostly from the east coast of Africa, and today is one of the most widely-consumed species as a result of controlled breeding in coastal areas.

The most important prawns and shrimps on Spanish coasts include red prawns from Palamos (Aristeus antennatus), which inhabit the waters of the Mediterranean, where they can be found between 150-1500 meters offshore, generally at a depth of 200-400 meters. The size of its head is almost half its total length, its shell is bluish, its antennae are very long, and it is the only variety that carries the eggs inside its head. There are also white prawns from Huelva (Parapenaeus longirostris), which are caught mainly in the Atlantic but also in the Mediterranean. They come from depths of between 180 and 450 meters and are pink, with the largest specimens reaching around 15cm in length; and the shrimp from Vinaroz (Penaeuskerathurus), which is caught along the Mediterranean and Atlantic Spanish coast; they are pale pinkish-brown with transverse brown rings on the abdomen that turn bright red once cooked. They can reach 20 centimeters in length.

In Chile, two main types of shrimp are consumed; the red shrimp (Pleuroncodes monodon) and the yellow shrimp (Cervimunidajohni): They are found in areas near the seabed between 200 and 400 meters depth off the central and southern Chilean coast.

The striped shrimp or common prawn (Palaemon serratus) inhabits rocky bottoms covered with algae and is usually found along the coast and up to 10 meters depth. It is nocturnal, spending most of the day hidden in the cracks and holes in the rocks. It is found all over the Atlantic, from Denmark to Cabo Blanco, and in the Mediterranean from Gibraltar up to the Black Sea, Israel and Egypt.

The river shrimp (Palaemon longirostris) has a face which varies in length depending on whether it is a male or a female; very long in females and short in males. It is transparent and almost colorless, with no markings and up to 7 centimeters in length. It is found in the river Guadalquivir.

In Mexico, the most important fishing area for shrimp in the Gulf of Mexico is the Sonda de Campeche. The following species are mainly caught in this area; pink shrimp (Farfantepenaeus duorarum), also known as spotted shrimp (Penaeus duorarum), brown shrimp (Farfantepenaeus aztecus), white shrimp (Litopenaeus setiferus) and Atlantic seabob (Xiphopenaeus kroyeri).

Normally, in order to extract flavoring from these crustaceans, the whole body or whole head is used. Any flavoring product obtained in this way, while having the flavor sought, includes other substances that do not contribute to the flavor, such as chitin, and ultimately their presence not only dilutes the flavor of the final product obtained but also changes the nutritional quality of the food composition or of the product subsequently prepared with it.

What was sought was a superior product that would be stable for alimentary purposes and of similar constitution, and with a high degree of flavoring power, i.e. that a small amount of the flavoring product would generate a high sensory impact.

### SUMMARY OF THE INVENTION

It is, therefore, the subject of this invention, a process for the preparation of a powdered flavoring base don macruran decapod crustaceans, that comprises:

a) having macruran decapod crustacean cephalothoraxes kept at no more than about 2 degrees centigrade;

b) optionally adding vegetable oil to the cephalothoraxes;

c) heat treating the cephalothoraxes using dry heat at a temperature of between about 160 and about 180 degrees centigrade so that the inside reaches approximately 70 degrees centigrade for a period of approximately 2 minutes;

d) extracting the hepatopancreas of the cephalothorax in liquid form;

e) filtering the creamy liquid obtained without pressure, separating the solids present;

f) lyophilizing the filtrated product obtained in e); and

g) grinding the product obtained by lyophilization to a powder with a particle size from about 5 μm to about 80 μm.

Preferably, the macruran decapod crustaceans are selected from the group consisting of langoustines, prawns, shrimps or morphologically similar crustaceans.

More preferably, langoustines are Patagonian langoustines (Pleoticusmuelleri).

In a preferred form, the dry heat source is a surface heated by gas or by electricity, with the heat transferred via a surface of cast iron, a ferrous alloy sheet, a metal sheet coated with Teflon, a stainless steel sheet.

Alternatively, the dry heat source is a stream of forced hot air applied to the cephalothoraxes while they pass along a conveyor belt.

Also alternatively, the dry heat source is a tunnel heated to produce heat produced by electrical elements or gas burners where the cephalothoraxes pass through the heated area while traveling on a conveyor belt.

Preferably, step d) is performed by pressing the cephalothoraxes in a sieve with a steel or ceramic tool putting pressure on the heads in the meshed plate of the sieve.

Alternatively, step d) is performed with a press with collector channels.

Also alternatively, step d) is performed by a centrifuge machine.

Preferably, step d) is performed at a pressure of about 310 kPa (45 psi or 3.1 kg/cm²).

It is another subject of this invention, a flavoring product obtained by the previously described process, wherein the macruran decapod crustacean cephalothoraxes come from Patagonian langoustines (Pleoticusmuelleri).

In a preferred form, the flavoring product is a powder of between about 5 μm and about 80 μm particle size and comprises about 39% protein which does not include chitin, approximately 43.0% lipids and about 8.0% ash.

Also in a preferred form, lipids comprise: about 24.2% saturated fatty acids, about 38.67% monounsaturated fatty acids, about 35.15% polyunsaturated fatty acids (PUFAs), and about 27.23% fatty acids ω3.

Yet, another subject of this invention is a flavored cooking salt which comprises from about 10% w/w to about 15% w/w of the flavoring powdered product by the previously described process, mixed with sea salt or salt flakes for culinary use, wherein the % w/w refer to the final mix.

### DETAILED DESCRIPTION OF THE INVENTION

In order to clarify the description of the invention, the terms “approximately”, “in the order of”, “about”, or the like employed in the specification mean that the numerical values involved are close to the specifically mentioned limit and within a certain range of values and comprised between more and less 20% of said numerical value, preferably between more and less 10% of said value and, even more preferably, between more and less 5% of said value. The ranges are determined by the measurement method employed and the confidence limits used in the relevant measurements. Likewise, since the raw material used in this invention is naturally-derived, variations can be expected within theses ranges due to seasonal variations, development of individuals, diet, etc., which naturally produce modifications in the analytical values obtained for a certain collection of samples used as representative of a universe.

The preparation process of a flavoring based on decapod macruran crustaceans according to the present invention consists of a series of stages, which are detailed later. For the purpose of the present description, it should be understood that the word “shrimp” is used interchangeably to mean shrimp, prawn, langoustine or any other macruran decapod crustacean with a similar morphological structure that may serve as raw material for the purpose of this invention.

We used, without suggesting any limiting consideration, raw Patagonian shrimp heads (Pleoticus muelleri) as the base ingredient.

An organ called the hepatopancreas is extracted from these shrimp heads or cephalothoraxes, and it is then lyophilized after heat treatment.

In processing plants for fresh shrimps, the head of this shellfish is removed as part of the natural cleaning process for cleaning the flesh of the abdomen for packaging and selling.

The head or cephalothorax of the shrimp from which the currently sold product is produced, is a waste product from the exploitation of this shellfish.

Because it has no commercial or other use, tons of this waste product are currently thrown away and left to rot every year.

The cephalothorax of the fresh shrimp should be kept at a temperature not greater than 2 degrees centigrade throughout the process, prior to harvesting the hepatopancreas and treating it with heat. In other words, from the time that the shellfish is caught to the heat treatment that is applied to the hepatopancreas, it has to be kept at that temperature.

Prior to the heat treatment of the hepatopancreas, a number of previous stages are carried out, comprising:

Extraction of the shrimp from the sea during a fishing day by ships authorized for that purpose.

Maintenance and refrigeration of the raw whole shrimps at no more than 2 degrees centigrade during the process of separation of the cephalothorax from the fleshy body.

Maintenance and refrigeration of the shrimp cephalothoraxes at no more than about 2 degrees until they are subjected to heat treatment.

Either fresh shrimp heads or frozen shrimp heads can be used as the raw material for the process of this invention.

The heat treatment of the shrimp cephalothoraxes, with or without the previous addition of vegetable oil by spraying or aerosol, is designed to use dry heat to bring the internal core temperature of the shrimp to approximately 60 degrees centigrade. This enhances the removal of the hepatopancreas and also serves to eliminate bacteria and/or neutralize/reduce possible bacterial growth in the future.

The type of vegetable oil used is optional and is not essential. Any good quality vegetable oil is suitable.

This heat treatment for obtaining the desired internal temperature in the cephalothorax of the shrimps must be carried out for a period of about 2 minutes. The optimum temperature applied to the cephalothorax must not be less than about 160 degrees centigrade nor greater than about 180 degrees centigrade.

How the heat-treatment is done is not important, what is important is to reach the designated temperature within the time indicated, as a heat treatment at lower temperatures would result in a product with greater potential bacterial growth.

The internal temperature of the heads should not be raised to more than about 70 degrees centigrade as the hepatopancreas, when extracted, would coagulate too much and not be obtained in the same proportion, quality and quantity.

The dry heat source applied to the shrimp cephalothorax can be of different types. Indeed, this heat source may consist of a surface heated by gas or by electricity, with the heat transferred via a surface of cast iron, a ferrous alloy sheet, a metal sheet coated with Teflon or a stainless steel sheet or it may be a stream of forced hot air applied to the cephalothoraxes while they pass along a conveyor belt or it may be a tunnel heated by electrical elements or gas burners where the cephalothoraxes pass through the heated area while traveling on a conveyor belt.

Once the shrimp cephalothoraxes reach the internal temperature mentioned above, they should be subjected to pressing through a mesh sieve or colander, crushing the thermally treated cephalothorax and extracting through pressing on one hand the hepatopancreas in the form of a liquid and on the other hand the remains of the crushed shrimp cephalothoraxes with the hepatopancreas removed.

On a small scale, it is possible to press the cephalothorax in a sieve suitable for straining using a steel or ceramic tool, putting pressure on the heads in the meshed plate of the sieve, and thereby extract the liquid product. Other types of presses with collector channels may be used on larger scales of production. The pressure needed to be applied to the heat-treated cephalothorax in order to extract the liquid hepatopancreas is approximately 310 kPa (45 psi or 3.1 kg/cm²).

An industrial centrifuge machine or a centrifuge used for the centrifugation of food for human and/or animal consumption is also an excellent system to extract the hepatopancreas.

The crushed cephalothoraxes that have had the hepatopancreas extracted from them are waste.

The resulting product is an orange liquid with light brown tones and a creamy texture, which surprisingly has a very characteristic, strong, concentrated shrimp flavor.

The creamy liquid is then filtered through, for example, a fine double mesh without exerting pressure on the product, simply letting it pass through the filter only by gravity and/or vibration. As a result, the solid parts of the product in the fluid and any possible pieces of the exoskeleton that were part of the shrimp cephalothorax are strained off.

A double mesh strainer can be used as a filter, with the smallest mesh possible, to retain the highest proportion of solids.

The filtered product is collected in sterile containers for storage either for transporting the product in its liquid state to the next stage of processing or for storage under appropriate conditions.

The resulting filtered product from the second filtering should be refrigerated to no more than about 2 degrees centigrade or subjected to freezing immediately, to preserve its quality, properties and freshness.

The product from second filtering is subjected to lyophilization for about 8 hours to dry it and stop any possible bacterial reproduction.

During the lyophilization process, the product of the second filtering is vacuum packed and frozen at temperatures of about −40 degrees centigrade (40 degrees below zero centigrade). The lyophilization process is a commonly employed method in the drying of products for human consumption.

A unit for lyophilizing food products, as it is known in the art, can be used to this effect.

The freeze-drying process results in a product obtained from the hepatopancreas of the treated shrimp, and this powder has an intense seafood or shrimp flavor which is rich in animal protein and fatty acids.

The product obtained after the lyophilizing is a dry mass that when being manipulated becomes a powder that can be directly used. The milling after lyophilizing has the aim of increasing its capacity of mixing with other products, easily transferring the characteristic shellfish or shrimp flavor homogeneously. Moreover, the subsequent milling avoids the possibility of feeling in the mouth possible crunchy or “sandy” textures that the obtained product has after lyophilizing.

After this, the freeze-dried powder is subjected to a mechanical process to reduce particle size by comminution or milling, so that the product does not have a ‘crunchy’ texture when it is used.

This mechanical grinding process can be performed with any mill used for the reduction of the particle size of food products.

The resulting particle size should be between about 5 μm to about 80 μm.

The powdered flavoring product resulting from the lyophilization, which is carried out in a specialized lyophilization plant for food products, or the powder obtained from milling this product, is packed into sterilized containers for storage and transportation.

The powdered product thus obtained can be used as a flavoring powder for the human food industry and also for the pharmaceutical industry. It can also be used to provide rations in the food industry for both land and sea animal breeding farms.

Also, this product can be formulated to make flavorings of all kinds that can be marketed as such directly to any consumer who wishes to use it in the preparation of home-cooked meals.

Physical, Chemical and Microbiological Analysis of the Product Obtained by the Process of this Invention

| | | | |
|---|---|---|---|
| Analysis | Method | Result | Remarks |

Physical and chemical measurements

| Water | Gravimetric | 3.1 ± 0.1% | — |
|---|---|---|---|
| | AOAC 950.46 | | |
| Proteins | Kjeldahl | 39.0 ± 0.4% | — |
| | AOAC 928.08 | | |
| Lipids | Soxhlet | 43.0 ± 0.5% | — |
| | AOAC 985.15 | | |
| Ash | Gravimetric | 8.0 ± 0.1% | — |
| | AOAC 938.08 | | |

| | | | |
|---|---|---|---|
| Carbohydrates | By contrast | 6.9% | — |
| Total volatile basic | Antonacopoulos | 76 ± 6 mg | — |
| nitrogen | | NBV/100 g | |
| Peroxide index | AOAC 965.33 | <1 meq O₂/kg | — |
| | | lipid extracted | |

Microbiological measurements

| | | | | |
|---|---|---|---|---|
| Total mesophilic | ICMSF 2000, | 2000 | UFC/g | — |
| aerobes | Met. 1 | | | |
| Molds and yeasts | ISO 4833:2003 | <100 | UFC/g | — |
| Total coliforms | Compact Dry | <10 | UFC/g | — |
| E. coli | Compact Dry | <10 | UFC/g | — |
| St. aureus coag.- | ICMSF | <10 | UFC/g | — |
| positive | | | | |
| Sulphite-reducing | APHA | <10 | UFC/g | — |
| anaerobes | | | | |

| | | | |
|---|---|---|---|
| Salmonella spp. | FDA | Absence en 25 g | — |

AOAC: English acronym for “Association of Official Analytical Chemists”.

Antonacopoulos; It makes reference to a direct distillation method for the determination of the total volatile basic nitrogen (TVBN) in fish samples or similar, described by Antonacopoulos (1968);

ICMSF: English acronym for “International Commission for the Microbiological Specifications of Foods”.

ISO: English acronym for “International Organization for Standardization”.

Compact Dry: HyServe GmbH & Co. KG trademark for a method of a ready to use microbiological assay. Particularly, with Compact Dry EC (E. Coli and coliforms) coliforms and E. Coli can be detected and distinguished. The means contains two chromogenic enzymatic substratum: Magenta-GAL and X-Gluc. In this way, the coliforms develop a red color, while that of the E. Coli is blue. The sum of the red and blue colonies results in the total number of the coliform group.

APHA: English acronym for “American Public Health Association”.

FDA: English acronym for “Food and Drug Administration (US)”.

For comparative purposes, the data obtained from flour made from farmed shrimp heads in Colombia by Andrade Pizarro, Ricardo D., et al, ‘Assessment of the Stages Of Cooking And Drying In The Preparation Of Flour made from Heads of Farmed Shrimp (Penaeus Sp)’ is given below; Dyna, Year 74, No.153, pp 181-186. Medellin, November 2007. ISSN 0012-7353.

In Table 3 of this article, the shrimp head flour is analyzed as follows:

Flour from Baking 95° C./10 min and Dried at 75° C./5 Hours

| Characteristics | No |
|---|---|
| Humidity (%) | 3.940 |
| Protein (%) | 50.265 |
| Fat (%) | 6.570 |
| Ash (%) | 19.580 |
| Particle diameter (mm) | 0.25-0.60 |
| Apparent density (g/cm³) | 0.390 |
| Mesophilic aerobes | 95 |
| Total coliforms (MPN) | <3 bacteria/g |
| Fecal coliforms (MPN) | <3 bacteria/g |

### MPN: Most Probable Number

It should be noted that the total protein also includes chitin, the protein from the shell which is of no use. The average quantity of usable protein is around 20%.

### Analysis of the Lipid Fraction Composition

Starting from a dry sample of the product obtained by the process described in this invention, lipid extraction by the Soxhlet method (or AOAC 985.15) was performed by using petroleum ether as solvent at 35-60° C. N₂ was passed through the extracted oil to remove solvent residues and create an inert atmosphere in order to prevent lipid oxidation. On the extracted oil with a 43.0% yield, expressed on dry sample, the detection and quantification of the fatty acids was performed by gas chromatography (AOCS, “American Oil Chemists Society”), Official Method Ce 2-66/Ch 2-91). The result of the fatty acid profile was as follows:

| Fatty Acids | % w/w |
|---|---|
| Myristic (14:0) | 2.60 |
| Pentadecaenoic (15:0) | 0.67 |
| Palmitic (16:0) | 15.11 |
| Palmitoleic (16:1) | 10.04 |
| Margaric (17:0) | 1.02 |
| Heptadecenoic (17:1) | 1.09 |
| Stearic (18:0) | 3.24 |
| Oleic (18:1) | 23.80 |
| Linoleic (18:2) | 3.20 |
| Linolenic (18:3 ω̅3) | 0.51 |
| Arachidic (20:0) | 0.19 |
| Eicosanoic (20:1) | 2.56 |
| Arachidonic (20:4) | 2.40 |
| Eicosapentaenoic (EPA, 20:5 ω̅3) | 12.42 |
| Erucic (22:1) | 0.36 |
| Docosapentaenoic (22:5) | 2.32 |
| Docosahexaenoic (DMA, 22:6 ω̅3) | 14.30 |
| Lignoseric (24:0) | 1.37 |
| Nervonic (24:1) | 0.82 |

From the values above, the quantities present of the following groups of acids can be established as follows:

Saturated fatty acids: 24.2%

Monounsaturated fatty acids: 38.67%

Polyunsaturated fatty acids (PUFA): 35.15%

Fatty acids ω3: 27.23%

Sensory Analysis and Tests made on the Shrimp Hepatopancreas Powder

Products assayed: Flavoring powder made from whole shrimps and flavoring powder made from shrimp hepatopancreas prepared as described in this invention.

Tests applied to:
1. A mix of the flavoring powder made from shrimp hepatopancreas with flakes of sea salt.
2. A mix of the flavoring powder made from shrimp hepatopancreas with a creamy rice.

With the flavoring products and the interactive contribution of 6 people, tests were made for flavor, texture and aroma of the powder.

The products were mixed with sea salt and salt flakes for culinary use, and the result was a shrimp salt with the correct balance of strength and performance. The proportion of flavoring product used was 12.5% w/w of the product as regards the final composition.

Amounts close to this % w/w value were also appropriate so that the flavoring product can be added to sea salt or salt flakes for culinary use from approximately 10% w/w up to approximately 15% w/w of the final composition, obtaining satisfactory results in terms of quality. A mixture with 12.5% w/w of flavoring product added to the salt was chosen, with the aim of assessing its abilities in this assay.

The salt prepared with flavoring powder made from whole shrimps was exceeded by between about 85 and 90% by the salt prepared from the shrimp flavoring powder prepared according to the present invention.

Subsequently creamy rice was cooked; the flavoring powder made of whole shrimps was added to some portions of the rice, and the flavoring powder obtained by the process of the present invention was added to other portions.

In order to obtain the creamy rice for the assay, 15 grams of the flavoring product were used in 1.5 liters of water to cook 200 grams of “short-grain” rice, Carnarolli type.

These portions were analyzed by the 6 members in a taste test which examined aroma, texture, flavor intensity and overall performance.

The result was creamy rice with an excellent shrimp flavor where the powder prepared according to the present invention exceeded by about 80% the flavor achieved with the flavoring powder based on whole prawns. The texture of the flavoring powder from this invention disappeared in the preparation leaving flavors, aromas and a slightly orange color.

It was concluded that the sensory analysis and tasting of the product had been excellent and that the addition of flavor and desired aroma of shrimp had been achieved using about 20% of flavoring powder compared with the amount of flavoring powder used that had been made with whole prawns.

### Sensory Analysis of a Lyophilized Shrimp Hepatopancreas Powder Sample.

### Assessment of Differences.

### Sensory Analysis

Differences were analyzed via a triangular test between a sample of lyophilized shrimp hepatopancreas, identified as I and three potential competitors in the market: M1, a paste product designed to make fish soup “Shrimp Paste”, from Thailand; M2, dried shrimps “Dried Shrimp”, from China; and M3, a powder product designed to make fish soup “Seafood Flavor” also from China.

Marketplace samples (M) were received in their original packaging, that is, sealed bags (M2 y M3), and a closed plastic container (M1); while the sample of this invention (I) was in a disposable plastic container.

### Methodology

Tests were performed in accordance to the general guidelines of ISO Standard 4120:2004 (IRAM 20008:1997), in a standardized tasting room according to ISO 8589 (2006) during four separate sessions. Colored lights (red and green) were used in all the tests to cover the appearance/color of the samples so that the choice is made by the taste of the sample only.

The following triangular tests were performed:

A) Sample I, according to this invention, with M1 “Shrimp Paste.

B) Sample I, according to this invention, with M2 “Dried Shrimp”.

C) Sample I, according to this invention, with M3 “Seafood Flavor”.

### Test A

Working samples were prepared mixing 2 grams of product per 200 grams of milk cream (trademark “Milkaut”), and performing a reduction of the mixture over an electric stove during 7 minutes. The samples were submitted to the evaluators in triads statistically balanced in thermal containers (glasses) labeled with three digit random codes at (47±3) degrees Celsius.

### Test B

The comparing product (small dried shrimps) was first ground to a powder. Then, then omelettes were made, shrimp or prawn omelette type, with the products being compared. The omelettes were made by mixing 6 grams of powdered product for every 3 eggs. The omelettes were cooked in a frying pan previously covered with a light film of sunflower oil and over an electric stove.

The resulting samples were submitted to the evaluators in triads statistically balanced in thermal tray-like containers labeled with three digit random codes at (47±3) degrees Celsius.

### Test C

Soups were prepared with a concentration of 10 g of each product per liter of water, adding 100 g of pasta, being snail-type noodles in 3 colors. The soup with the product of the invention or Sample I, was made with a base sauce with half an onion finely chopped and oil, in order to obtain a consistency similar to that of the product in the market.

The samples were submitted to the evaluators in triads statistically balanced in thermal glass-shape containers labeled with three digit random codes at (47±3) degrees Celsius.

### Results and Conclusions□

Test A: Over a total of 21 evaluations (n=21), the total corresponded to positive results in terms of identification of differences. The samples were different with a confidence level of 99.99% and a probability P<0.001 (other than 0.1%).

Test B: Over a total of 18 evaluations (n=18), 16 corresponded to positive results in terms of identification of differences. The samples were different with a probability P<0.001 (other than 0.1%).

Test C: Over a total of 15 evaluations (n=15), 11 corresponded to positive results in terms of identification of differences. The samples were different with a probability P<0.01 (other than 1%).

Overall, over a total of 54 evaluations (n=54), 49 corresponded to positive results in terms of identification of differences.

According to the following table of significance:

□□ In order to be able to say that the samples are different with 20% error or probability of error, 22 evaluations should have been identified as different.

□ In order to be able to say that the samples are different with 10% error or probability of error, 23 evaluations should have been identified as different.

□ In order to be able to say that the samples are different with 5% error or probability of error, 25 evaluations should have been identified as different.

□ In order to be able to say that the samples are different with 1° A error or probability of error, 27 evaluations should have been identified as different.

□ In order to be able to say that the samples are different with 0.1° A error or probability of error, 30 evaluations should have been identified as different.

Based on the above, we conclude that the samples are different from each other with probability p<0,001, this is, different than 0.1%.

### Observations

While not the purpose of this test, it is worth noting that the majority of the evaluators in the three tests found Sample I of the invention to be “more natural”, “less aggressive” and/or “with more of a fish taste” than the commercial comparative Samples M used in the test.

Other RAM and ISO standards used were: ISO 5492:1992 (IRAM 20001:1995) for the sensory analysis vocabulary and ISO 6658:1985 (IRAM 20002:1995) on general guidelines for the sensory analysis methodology.

### Industrial Applicability of the Invention

This invention can be applied in any industry related to the production of seasonings and flavored food, as well as the fishing industry, where part of the currently unused residues and waste will be reduced. These industries will greatly benefit from having a process for the preparation of a powdered flavoring based on macruran decapod crustaceans, a powdered flavoring product obtained from it and a cooking salt flavored with the latter.

The direct benefit of employing a process for the preparation of a powdered flavoring based on macruran decapod crustaceans, the powdered flavoring product obtained from it and the cooking salt flavored with the latter is having stable products for alimentary purposes, with similar constitution, and with a high degree of flavoring power.

### Final Considerations

Several modifications and variations of the process for the preparation of a powdered flavoring based on macruran decapod crustaceans, the powdered flavoring product obtained from it and the cooking salt flavored with the latter described according to this invention will be apparent to those skilled in the art without departing from the scope and spirit of the invention. While the invention has been described in relation to preferred embodiments, it shall be understood that said invention, as it is claimed, should not be unduly limited to said specific embodiments. In fact, the different modifications of the method described to perform the invention, which are apparent for those skilled in the relevant art or related arts, are intended to be included within the scope of the following claims.

The claims are part of the disclosure of the invention, which is the subject of this patent application.

1. A process for the preparation of a flavoring powder based on macruran decapod crustaceans comprising the following steps:
a) having macruran decapod crustacean cephalothorax kept at a temperature not higher than 2 degrees centigrade;
b) optionally adding vegetable oil to the cephalothorax;
c) heat treating the cephalothoraxes with dry heat at a temperature approximately between 160 and 180 degrees centigrade so that the interior reaches approximately 70 degrees centigrade for a period of about 2 minutes;
d) extracting the hepatopancreas from the cephalothorax in liquid form;
e) filtering out the creamy liquid without exerting pressure to separate any solids present;
f) lyophilizing the filtered product obtained in e); and
g) grinding the product obtained by lyophilization to a powder with a particle size from about 5 μm to about 80 μm.

2. The process according to claim 1, where the macruran decapod crustaceans are chosen from the group consisting of langoustines, shrimps, prawns, or morphologically similar crustaceans.

3. The process according to claim 2, where the shrimps are Patagonian shrimps (Pleoticusmuelleri).

4. The process according to claim 1 where the dry heat source is a gas or electrically heated surface where the heat transfer medium is a surface of cast iron, a ferrous alloy plate, a metal sheet coated with Teflon, or a stainless steel sheet.

5. The process according to claim 1 where the dry heat source is a stream of forced hot air applied to the cephalothoraxes while they pass along a conveyor belt.

6. The process according to claim 1 where the dry heat source is a tunnel heated to produce heat produced by electric elements or gas burners where the cephalothoraxes pass through the heated area while traveling on a conveyor belt.

7. The process according to claim 1 where step d) is performed by pressing the cephalothoraxes in a sieve using a steel or ceramic tool to press down on the heads in the meshed plate of the sieve.

8. The process according to claim 1 where step d) is carried out with a press with collector channels.

9. The process according to claim 1 where step d) is carried out by means of a centrifuge machine.

10. The process according to claim 7 where step d) is performed at a pressure of about 310 kPa (45 psi or 3.1 kg/cm²).

11. A flavoring product obtained by the process of claim 1 where the macruran decapod crustacean cephalothoraxes come from Patagonian shrimps (Pleoticusmuelleri).

12. The flavoring product according to claim 11, comprising a powder of about 5 μm to about 80 μm particle size, and comprising about 39% protein which does not include chitin, about 43.0% lipids and about 8.0% ash.

13. The flavoring product according to claim 12, where the lipids comprise: about 24.2% saturated fatty acids, about 38.67% monounsaturated fatty acids, about 35.15% polyunsaturated fatty acids (PUFAs), and about 27.23% fatty acids ω3.

14. A cooking flavored salt comprising from about 10% w/w to about 15% w/w of the powdered flavoring product obtained by the process of claim 1, mixed with sea salt or salt flakes for culinary use, where the % w/w fefef refers to the final mix.

15. The process according to claim 8, where step d) is performed at a pressure of about 310 kPa (45 psi or 3.1 kg/cm²).

16. The process according to claim 9, where step d) is performed at a pressure of about 310 kPa (45 psi or 3.1 kg/cm²).
